(19) United States
(12) Patent Application Publication
(10) Pub. No.: US 2018/0047020 A1
(43) Pub. Date: Feb. 15, 2018

(54) METHOD AND SYSTEM OF CONDUCTING A TRANSACTION

(71) Applicant: SNIIP (AUSTRALIA) PTY LTD, Hendra, Queensland (AU)

(72) Inventor: Damien VASTA, Hendra, Queensland (AU)

(21) Appl. No.: 15/556,119

(22) PCT Filed: Mar. 10, 2015
(86) PCT No.: PCT/AU2015/050094

§ 371 Date: Sep. 6, 2017

(51) Int. Cl. G06Q 20/40; G06Q 20/38; G06Q 20/32

(52) U.S. Cl. CPC G06Q 20/405; G06Q 20/3276; G06Q 20/3829

(57) ABSTRACT

A convenient and efficient method and system of conducting a transaction using a user's mobile device, such as a mobile phone or tablet, to scan an electronically readable element such as a 2D barcode (preferably a QR Code) associated with a product such as a good, service, fine, or fee, or the like. The mobile device is configured to scan the electronically readable element, load information relating to the product, and allow the user to authorise a transaction associated with the product to a provider after which the mobile device retrieves securely stored payment details and transfers them to a payment gateway associated with the provider to complete the transaction.

### FIELD OF THE INVENTION

The invention relates to a method and system of conducting a transaction. In particular, the invention relates, but is not limited, to a method and system of conducting a transaction using a user's mobile electronic device, such as a cell phone or tablet, to scan a transaction identifier and authorise payment to a provider.

### BACKGROUND TO THE INVENTION

Reference to background art herein is not to be construed as an admission that such art constitutes common general knowledge.

Trade and commerce for the purchase of goods and services has been around for centuries. More recently, with the advent of modern communication services such as the Internet, e-commerce (or ‘ecommerce’) has developed where consumers can purchase goods and services online. Typical e-commerce transactions involve a user browsing to find a good or service of interest, adding that good or service to a virtual ‘cart’ or shopping bag, inputting personal details such as billing address and delivery address, and then paying for the goods or services.

Typically, payment is handled by presenting the user with a variety of options, with the most common being credit card. Credit card payments then require a user to input credit card payment details, unless they have been saved from a previous transaction. Another common payment method is to utilise a payment service such as PayPal. PayPal stores the user's credit card details and address, which is more convenient than credit card transactions, but still requires the user to input a username and password to authorise the transaction.

While reasonably convenient, it is acknowledged that such processes often require a number of steps and a more streamlined process would be preferable. While some retailers have adopted more streamlined processes based on stored information, such as the Amazon ‘1-click’ system, these only apply to purchases made with those retailers, and it's still necessary to save details with each retainer and then to log into an account in order to make a purchase.

Furthermore, there is a disconnect between physical advertisements, such as brochures, circulars, newspapers, magazines, and posters and ecommerce. If a user sees an item they would like to purchase in a physical advertisement they either need to go to the store to complete the purchase or to browse the Internet to find the retailer selling the product and then proceed to complete the purchase in the usual manner. Not only are both of these options relatively inconvenient, but in browsing for the product a user may end up buying the product from another store, resulting in a lost sale to the retainer that provided the physical advertisement.

### OBJECT OF THE INVENTION

It is an aim of this invention to provide a method and system of conducting a transaction which overcomes or ameliorates one or more of the disadvantages or problems described above, or which at least provides a useful alternative.

Other preferred objects of the present invention will become apparent from the following description.

### SUMMARY OF INVENTION

In one form, although it need not be the only or indeed the broadest form, there is provided a method of conducting a transaction comprising:
scanning an electronically readable element associated with a product using a mobile device;
automatically retrieving details of the product including a monetary amount on the mobile device;
displaying details of the product on the mobile device;
authorising transfer of funds to a provider of the product;
retrieving payment details stored on the mobile device;
transferring stored payment details to a payment gateway associated with the provider;
receiving notification of a transaction using the transferred payment details for the product having occurred; and
displaying confirmation of the transaction on the mobile device.

Preferably the electronically readable element includes a barcode, even more preferably a two dimensional barcode. The electronically readable element may be a Quick Response (QR) code. Preferably the electronically readable element is adjacent, preferably located within, a visual identifier that indicates suitability for the element to be compatible with the method. Preferably the visual identifier comprises a circle around a two dimensional barcode.

Preferably the mobile device is a phone or tablet. Preferably the method further comprises the step of running a transaction application on the mobile device. Preferably the transaction application is configured to perform the steps of retrieving details of the product including a monetary amount on the mobile device, displaying details of the product on the mobile device, authorising transfer of funds to a provider of the product, retrieving payment details stored on the mobile device, transferring stored payment details to the payment gateway associated with the provider, and displaying confirmation of the transaction on the mobile device.

Preferably the step of authorising transfer of funds to a provider of the product comprises inputting authentication information. Preferably the authentication information comprises a pin number. Alternatively, or additionally, the authentication information comprises a biometric reading, a password, or an authorisation code from the mobile device.

Preferably the step of transferring stored payment details to the payment gateway associated with the provider is encrypted. Preferably the step of transferring stored payment details to the payment gateway associated with the provider is encrypted. Preferably at least a portion of the authentication information as an encryption key. Preferably the stored payment details are stored in a secure virtual wallet on the mobile device. Preferably the stored payment details are encrypted using AES encryption, even more preferably AES256 encryption. Preferably the stored payment details are encrypted using the authentication information as an encryption key.

Preferably the electronically readable element is provided on physical media. Preferably the step of scanning an electronically readable element associated with a product using a mobile device comprises scanning the electronically readable element using a camera of the mobile device. Preferably the camera of the mobile device scans the physical media to locate and scan the electronically readable element.

In another form, there is provided a method of conducting a transaction using a mobile device comprising:
identifying an electronically readable element;
reading the electronically readable element;
matching the electronically readable element to a product from a provider;
retrieving and displaying details of the product;
providing an authorisation mechanism to a user;
upon receiving authorisation from the authorisation mechanism:
   transmitting stored payment details to a payment gateway associated with the provider;
   receiving confirmation notification of a transaction using the transferred payment details for the product having occurred; and
   displaying confirmation of the transaction on the mobile device.

Preferably the mobile device is a mobile phone or tablet. Preferably the mobile device uses a camera to identify the electronically readable element. Preferably the mobile device uses the camera to read the electronically readable element. Preferably the electronically readable element is an optically readable two dimensional barcode.

Preferably the method further comprises the step of selecting preferred payment details for the transaction from a plurality of stored payment detail options. Preferably the authorisation mechanism requires a security input such as a pin number, a biometric reading (e.g. fingerprint), and/or a password.

Preferably the step of transmitting stored payment details to the payment gateway associated with the provider also comprises transmitting personal information such as, for example, name, address, and/or contact details of the user. Preferably the personal information is stored on the mobile device. Preferably a user is provided with an option to select personal details to be transferred. Preferably the user is the owner of the mobile device. The product may include goods, services, fees, or fines of the like. The transaction may be a purchase or bill payment.

In another form, there is provided a system of conducting a transaction comprising:
a mobile device configured to:
   scan an electronically readable element associated with a product;
   request details of the product from a remote server;
   receive details of the product from the remote service in response to the request;
   display details of the product on a display of the mobile device;
   request authorisation to make a transaction associated with the product; and
   upon receiving authorisation:
      retrieve payment details stored on the mobile device;
      transfer stored payment details to a payment gateway;
      receive notification of a transaction using the transferred payment details for the product having occurred; and
      display confirmation of the transaction on the mobile device.

Preferably the mobile device is a phone or tablet. Preferably the mobile device is configured by running a suitable application that utilises the hardware of the mobile device. Preferably the mobile device has a camera and scans the electronically readable element using the camera.

Preferably the system further comprises a physical medium which carries the electronically readable element. Preferably the physical medium is paper. Preferably the electronically readable element is printed on the paper. Preferably the electronically readable element is a two dimensional barcode located adjacent to information relating to the product. The paper may be an advertisement for a good and/or service for a monetary amount. Alternatively, the paper may be a bill or invoice requesting payment of a monetary amount.

Preferably the system further comprises a remote server that communicates with the mobile device. Preferably the remote server provides details of the product upon receiving a request. Preferably the remote server receives a successful transaction notification confirming that the provider has accepted the payment details. Preferably the remote server notifies the mobile device of the successful transaction notification after which the mobile device displays the confirmation of transaction.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates an example of a mobile device scanning an electronically readable element according to an embodiment of the invention;

FIG. 2 illustrates an example view of the mobile device displaying preferred payment details;

FIG. 3 illustrates an example view of the mobile device displaying an authorisation mechanism;

FIG. 4 illustrates an example view of the mobile device displaying confirmation of a transaction;

FIG. 5 illustrates a system diagram showing an example payment system; and

FIG. 6 illustrates a system diagram showing an example backend implementation.

### DETAILED DESCRIPTION OF THE DRAWINGS

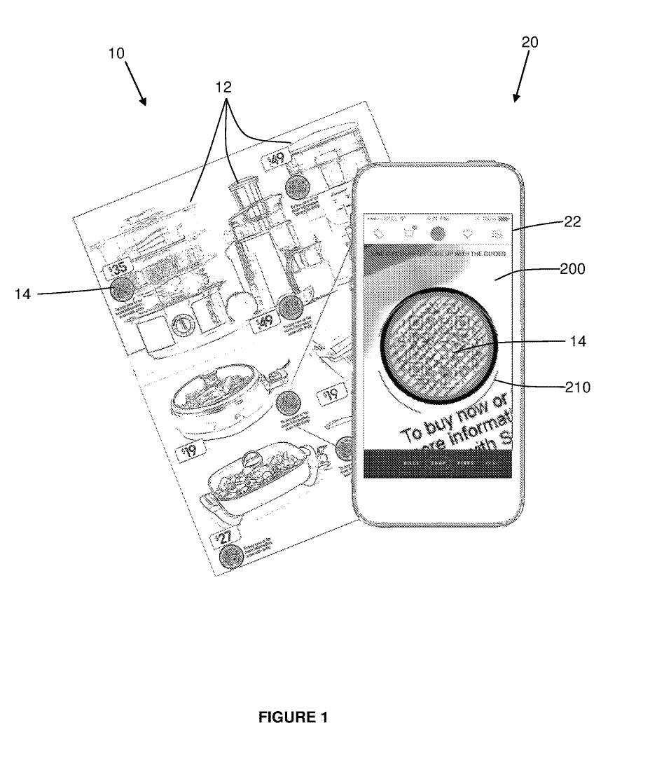

FIG. 1 illustrates an advertisement 10 in the form of a brochure or circular offering products in the form of goods 12 for sale. Each good 12 has a respective electronically readable element in the form of a visually identified ‘circular’ QR code 14. The QR codes 14 are located adjacent to the products such that a user can identify a QR code 14 associated with a particular good 12. The QR codes 14 in the illustrated embodiment have a visual identifier in the form of a circular border that encloses a standard square QR code therein.

Although FIG. 1 illustrates an advertisement with goods 12 for sale, it will be appreciated that the same principals apply in relation to other products such as, for example, services, fees, fines, or the like. QR codes 14 can be supplied on bills or invoices with application of the same principals. The invention will primarily be described with reference to making a purchase for a good but, where the context permits, no limitation is meant thereby.

FIG. 1 also illustrates a mobile device 20 in the form of a smart phone running a suitable application 200 shown on a display 22 of the device 20 to facilitate the method and system of the invention. The mobile device 20 has a camera (not shown—located on other side of mobile device 20) which can be aligned with a QR code 14 to scan that code. As the mobile device 20 is positioned above the advertisement 10 the display 22 of the mobile device 20 shows what is being scanned and a user can align a QR code 14 of interest with alignment indicators 210 of the application 200.

Once aligned, the application 200 on the mobile device 20 reads the QR code 14 and matches the code to a product which, in the illustrated example, is a good 12. The mobile device 20 then retrieves information relating to the good 12 and displays product information including a description of the product and a monetary amount, i.e. the price of the good in the example, from where the user can opt to purchase the product.

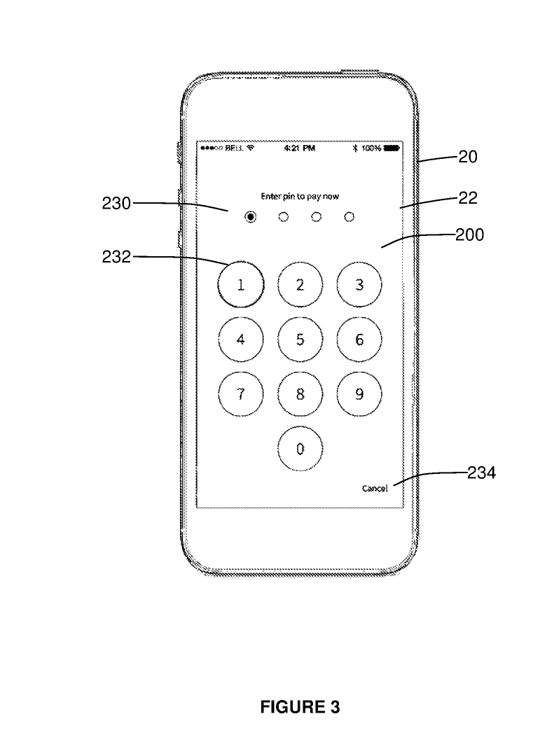

Payment details to pay for the product are stored securely on the mobile device 20 in an encrypted virtual wallet. In a preferred form the virtual wallet is encrypted using AES256 encryption that uses user authentication information as an encryption key. FIG. 3 illustrates a payment method page of the application 200 where payment details relating to the user have been retrieved from the virtual wallet on the mobile device 20. In the illustrated example credit card details 220 have been retrieved and a summary is presented to the user on the display 22 of the mobile device 20 to confirm whether this is the payment method they would like to use to continue the purchase. Monetary amount details 222 are provided, including whether any discounts or shipping apply, and a confirm button 224 is provided for a user to confirm whether they would like to proceed with the transaction by paying for the product using the retrieved payment details.

The user may have a plurality of payment details stored on the mobile device and may be presented with an option to select a preferred payment method from the plurality of options. For first time use the user may need to input payment details to be stored on the mobile device 20. Furthermore, if the user desires additional payment options they may need to input additional payment details to be stored on the mobile device 20. Once inputted, those payment details can be retrieved from the virtual wallet on the mobile device 20 to facilitate payment of the product.

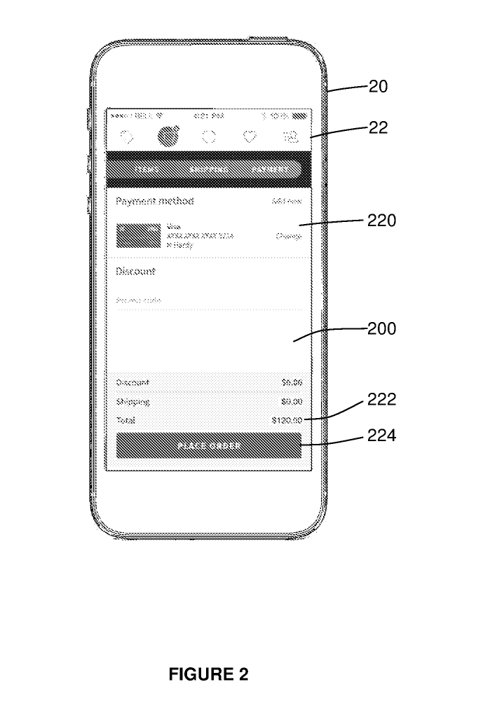

Once the user confirms they would like to proceed by clicking the confirm button 224 illustrated in FIG. 2, the application 200 on the mobile device 20 presents an authorisation mechanism to authorise the purchase. The user must input authentication information to pass the authorisation mechanism. FIG. 3 illustrates an authorisation mechanism in the form of a pin number. The pin number request 230 illustrated in FIG. 3 asks the user to input their authentication information in the form of a pin number to continue with the transaction. A keypad 232 is presented for the user to input their pin number. A cancel option 234 is also provided should the user decide not to proceed with the transaction at this stage.

Although the example illustrated in FIG. 3 relates to a four digit pin number, which is perceived as an authorisation mechanism that provides a reasonable balance between convenience and security, it will be appreciated that other authorisation mechanisms could be utilised instead, or as well as, the pin number. For example, the authorisation mechanism may include a biometric authorisation from a fingerprint reader or the like, a password or passphrase, facial recognition, and/or a security question.

Once the authorisation mechanism is successfully passed the application 200 transfers the stored payment details to a payment gateway associated with the provider. The payment gateway may be a payment gateway of the provider itself, or may be an intermediary gateway who handles payments for or on behalf of the provider. The payment gateway processing the payment details to facilitate payment from the user Once payment is successfully processed the payment gateway notifies the mobile device 20 that the transaction has occurred.

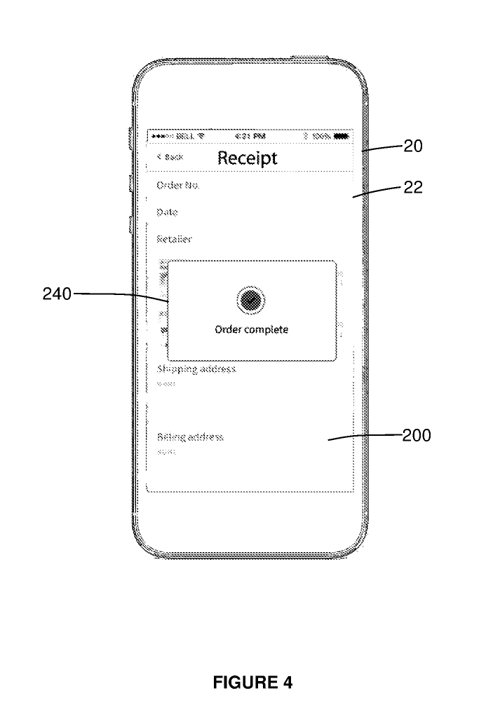

FIG. 4 illustrates the mobile device 20 displaying a confirmation message 240 of the transaction on its display 22 in response to receiving notification that the transaction has occurred. In addition to a confirmation 240 message 240, the application 200 displays transaction information including order no., date, retailer, shipping address, and billing address. The transaction information can be saved on the mobile device for future reference and as a receipt and proof of the transaction having been successful.

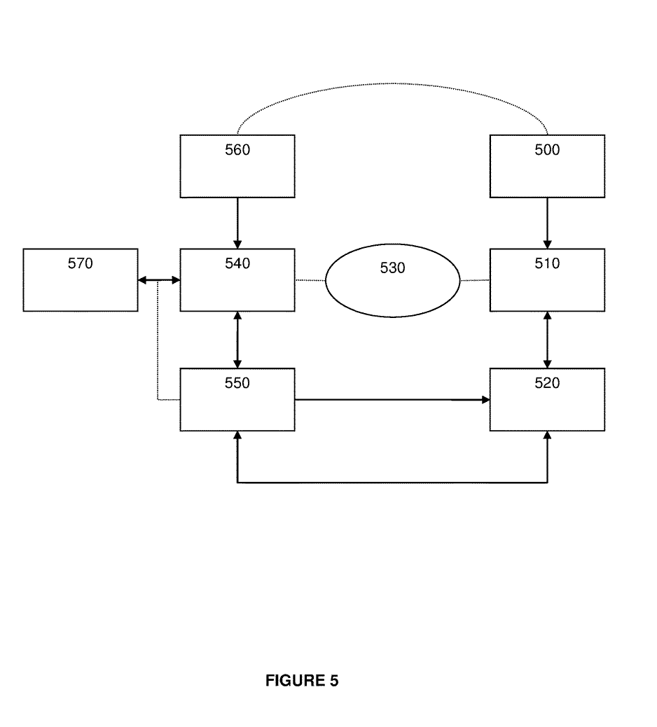

FIG. 5 illustrates a system diagram showing an example payment system for bill payment integration. A user 500 uses an application on a mobile device 510 which communicates with an application server 520. The mobile device 510 also establishes an application programming interface (API) to a payment gateway 530 which is in turn linked to a billing house 540. The billing house is connected to a billing server 550 and receives data from a provider 560 of the product. The billing house 540 is also connected to a print house 570 which generates billing codes and stores them on the billing server 550. The billing codes are updated by the print house 570 periodically, e.g. daily.

The billing server 550 sends the billing codes to the application server 520 periodically, e.g. daily. The application server 520 sends remittance data to the billing server 550 and the billing server sends remittance data to the application server 520 periodically to audit transactions and avoid duplicate payments. As transactions are made by mobile devices 510 the application server 520 automatically checks off billing codes for reconciliation.

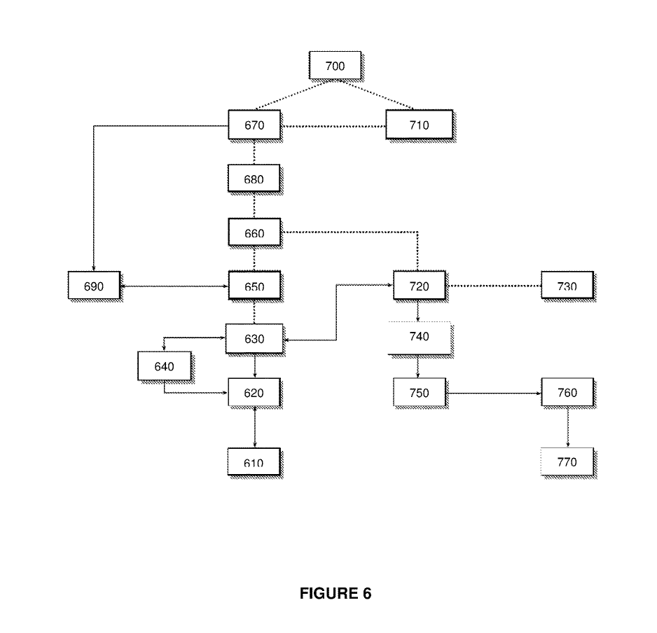

FIG. 6 illustrates a system diagram showing an example backend implementation 600 using Amazon Web Services (AWS) which is considered to be able to provide a robust and scalable system. A user 610 connects to a ‘route53’ DNS 620 with their mobile device. The ‘route53’ DNS is a scalable DNS service that connects user 610 requests to other backend services such as ‘EC2’ instances 630, which are spawned as required, and an AWS CloudFront 640 for static asset serving and content delivery. The EC2 instances 630 provide computing resources as needed and the AWS CloudFront 640 integrates AWS services via a content delivery web service.

The EC2 instances 630 are supported by elastic load balancers 650 which automatically distribute traffic over multiple EC2 instances to cater for times of increased demand. The backend 600 also makes use of an elastic beanstalk 660 for application deployment and updates.

A code repository 670 is connected to an AWS interface 680, and to the elastic load balancers 650 via Amazon Machine Images (AMI) 690. The code repository 670 may be a ‘git’ repository hosted by, for example, BitBucket. The AMI provides necessary information to the elastic load balancers 650 to launch EC2 instances 630 as required.

The code repository 670 is connected to an application server 700 and development tools 710 such as, for example, Atlassian Development Tools including BitBucket, Jira, and Confluence, or the like. The backend 600 includes a primary database 720. The primary database 720 includes a relational database service (RDS) such as MySQL and is in communication with a backup system 730. The backup system 730 uses an Amazon Simple Storage Service (S3) and then an Amazon Glacier backup at regular intervals.

The primary database 720 is connected to a data pipeline 740 which stages data for a data analytics system 750. The data analytics system may include AWS Redshift which is a managed petabyte-scale data warehouse which performs complex calculations and data analysis without running the primary database 720. The data analytics system 750 is connected to a NeuralCore 760 which can generate client reports 770 based on the data analysis.

Advantageously the present invention provides a method and system of conducting a transaction that is easy for a user to make a purchase by simple scanning the electronically readable element using their mobile device and by having the mobile device provide all necessary details to complete the purchase to a provider upon receiving an authorisation from the user. Users are therefore not discouraged to make purchases or payments as it the system and method is efficient and highly convenient.

Furthermore, the present invention also allows users to make ecommerce purchases from physical media, such as brochures, circulars, magazines, posters, or the like, with little effort and no manual searching involved. This further improves convenience upon traditional transaction systems and ensures that users automatically find details of the product of interest and can authorise payment without having to find or input further details such as payment or delivery details.

The method and system is safe secure, with the User's payment and personal details being stored locally on their mobile device itself, typically encrypted with AES encryption. The payment and personal details are only transferred to other parties upon receiving authorisation from the user. Once authorisation has been provided the payment and personal details are only transferred to the payment gateway associated with the provider of the product, and not to any intermediate servers such as the application server.

Not only does the system and method provide significant advantages for users, but it also provides significant advantages for providers. Users are encouraged to purchase from the provider of the product that is associated with the electronically readable element as once scanned the transaction is associated with that provider and the user is not forced to perform searching which may result in the user making the purchase from another provider. The system and method has many applications that can connect traditional commerce with ecommerce such as, for example, a store providing an electronically readable element in place of an out of stock item to allow users to seamlessly make an order for that item using that stores ecommerce systems.

The system and method can be integrated into existing ecommerce systems by providing a unique and convenient front end to their existing back end services. This reduces disruption and makes implementation relatively painless without necessarily effecting traditional ecommerce systems in place.

Throughout this specification the word product is used to describe a good or a service, and no limitation to a physical product, or the like, is meant thereby. A product may also include a fee or fine. Similarly, a provider may be a merchant, retailer, service provider, government agency, or the like.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1-31. (canceled)

32. A method of conducting a transaction comprising:
scanning an electronically readable element associated with a product using a mobile device;
automatically retrieving details of the product including a monetary amount on the mobile device;
displaying details of the product on the mobile device;
authorizing transfer of funds to a provider of the product;
retrieving payment details stored on the mobile device;
transferring stored payment details to a payment gateway associated with the provider;
receiving notification of a transaction using the transferred payment details for the product having occurred; and
displaying confirmation of the transaction on the mobile device.

33. The method of claim 32, wherein the electronically readable element includes a two dimensional barcode.

34. The method of claim 32, wherein the electronically readable element is located adjacent a visual identifier that indicates suitability for the element to be compatible with the method.

35. The method of claim 32, wherein the mobile device is a phone or tablet.

36. The method of claim 35 wherein a transaction application on the mobile device is configured to perform the steps of retrieving details of the product including a monetary amount on the mobile device, displaying details of the product on the mobile device, authorizing transfer of funds to a provider of the product, retrieving payment details stored on the mobile device, transferring stored payment details to the payment gateway associated with the provider, and displaying confirmation of the transaction on the mobile device.

37. The method of claim 32, wherein the step of authorizing transfer of funds to a provider of the product comprises inputting authentication information.

38. The method of claim 37, wherein the authentication information comprises one or more of a pin number, a biometric reading, a password, and/or an authorization code from the mobile device.

39. The method of claim 37, wherein the stored payment details are encrypted using AES encryption with the authentication information as an encryption key.

40. The method of claim 32, wherein the stored payment details are stored in a secure virtual wallet on the mobile device.

41. The method of claim 32, wherein the electronically readable element is provided on physical media.

42. The method of claim 32, wherein the step of scanning an electronically readable element associated with a product using a mobile device comprises scanning the electronically readable element using a camera of the mobile device.

43. A method of conducting a transaction using a mobile device comprising:
identifying an electronically readable element;
reading the electronically readable element;
matching the electronically readable element to a product from a provider;
retrieving and displaying details of the product;
providing an authorization mechanism to a user;
upon receiving authorization from the authorization mechanism:
transmitting payment details stored on the mobile device to a payment gateway associated with the provider;
receiving confirmation notification of a transaction using the transferred payment details for the product having occurred; and
displaying confirmation of the transaction on the mobile device.

44. The method of claim 43 wherein the mobile device is a mobile phone or tablet.

45. The method of claim 43, wherein the mobile device uses a camera to identify the electronically readable element.

46. The method of claim 43, wherein the mobile device uses he camera to read the electronically readable element.

47. The method of claim 43, wherein the electronically readable element is an optically readable two dimensional barcode.

48. The method of claim 43, further comprising the step of selecting preferred payment details for the transaction from a plurality of stored payment detail options.

49. The method of claim 43, wherein the authorization mechanism requires a security input.

50. The method of claim 49, wherein the security input includes authentication information that comprises one or more of a pin number, a biometric reading, a password, and/or an authorization code from the mobile device.

51. The method of claim 43, wherein the step of transmitting stored payment details to the payment gateway associated with the provider also comprises transmitting personal information.

52. The method of claim 51, wherein the user is provided with an option to select personal details to be transferred.

53. A system of conducting a transaction comprising:
a mobile device configured to:
scan an electronically readable element associated with a product;
request details of the product from a remote server;
receive details of the product from the remote service in response to the request;
display details of the product on a display of the mobile device;
request authorization to make a transaction associated with the product; and
upon receiving authorization:
retrieve payment details stored on the mobile device;
transfer stored payment details to a payment gateway;
receive notification of a transaction using the transferred payment details for the product having occurred; and
display confirmation of the transaction on the mobile device.

54. The system of claim 53, wherein the mobile device is a phone or tablet.

55. The system of claim 53, wherein the mobile device is configured to running an application that utilizes hardware of the mobile device.

56. The system of claim 53, wherein the mobile device has a camera and scans the electronically readable element using the camera.

57. The system of claim 53, further comprises a physical medium which carries the electronically readable element.

58. The system of claim 57, wherein the physical medium is paper and the electronically readable element is printed on the paper.

59. The system of claim 53, further comprising a remote server that communicates with the mobile device.

60. The system of claim 59, wherein the remote server provides details of the product upon receiving a request from the mobile device.

61. The system of claim 59, wherein the remote server receives a successful transaction notification confirming that the provider has accepted the payment details.

62. The system of claim 61, wherein the remote server notifies the mobile device of the successful transaction notification after which the mobile device displays the confirmation of transaction.
